(19) United States
(12) Patent Application Publication
(10) Pub. No.: US 2018/0140921 A1
(43) Pub. Date: May 24, 2018

(54) BASEBALL-TRAINING DEVICE

(71) Applicant: Mary Wolfe, Federalsburg, MD (US)

(72) Inventor: Mary Wolfe, Federalsburg, MD (US)

(21) Appl. No.: 15/356,620

(22) Filed: Nov. 20, 2016

(51) Int. Cl. A63B 69/00; G09B 19/00

(52) U.S. Cl. CPC A63B 69/0002; A63B 2069/0008; G09B 19/0038

(57) ABSTRACT

A baseball-training device disclosed here is configured for training a baseball player. The baseball-training device includes an elongate rod, a bearing assembly, a rope member, and a ball. The elongate rod is configured to be held by a first player, and the bearing assembly is fixedly attached at a distal end of the elongate rod. The rope member is attached to a projected ring on the circumference of the bearing assembly, and a ball is fastened to a distal end of the rope member. The first player rotates the elongate rod in a predefined direction to allow the ball to swing in a generally circular manner with respect to the axis of the elongate rod, where a second player is required to aim and strike the ball using a baseball bat.

### FIELD OF THE INVENTION

The present invention relates to a device for training baseball players. More particularly, the present invention relates to a baseball-training device, which allows the baseball players to train themselves in aiming and striking the baseball with a baseball bat.

### BACKGROUND

Baseball is a very popular game in different parts of the world, especially in the United States of America, and being able to strike the baseball with a baseball bat is a skill that necessitates significant practice to achieve. A baseball player needs to train in certain primary aspects, such as, appropriate hand-eye coordination, timing, and strength to develop into a skillful hitter. Unfortunately, most of the time, the amount of space available for practice is less to train at an actual ballpark, or an open field. In addition to that, it is usually non-practical and enormously time-consuming to train on batting in an open field. When the player strikes the ball, it travels in multiple directions and distances, and must all finally be recovered and returned to the actual batting position before continuing practice. This recovery process takes up a lot of time as well as energy, which could be well focused on the actual batting training itself.

Furthermore, the players who cannot afford a large open baseball field or an open space near their homes do not have the chance to practice any kind of practice methods. Such players often resort to train their batting proximal to their house itself. However, baseball training in close proximity to a house can prove to be extremely dangerous for the neighborhood property and the people who stay around. In order to adjust to such disadvantages pertaining to baseball batting practice, numerous players have tried to develop different methods but most of the methods fail primarily due to the space availability, which is a substantial problem. Therefore, there is a need for a method or a device for practicing baseball game, so that the players can gain skill in striking the ball correctly.

### SUMMARY OF THE INVENTION

The baseball-training device disclosed here is configured for training a baseball player. The baseball-training device comprises an elongate rod, a bearing assembly, a rope member, and a ball. The elongate rod is configured to be held by a first player, and the bearing assembly is fixedly attached at a distal end of the rod. The rope member is attached to a projected ring on the circumference of the bearing assembly, and a ball is fastened to a distal end of the rope member. The first player rotates the elongate rod in a predefined direction to allow the ball to swing in a generally circular manner with respect to the axis of the elongate rod, where a second player is required to aim and strike the ball using a baseball bat.

In an embodiment, the rope member is of any predefined length. In an embodiment, the ball fastened to the distal end of the rope member is either a soft ball or a hard ball, and the ball is of a predetermined size. In an embodiment, the baseball-training device further comprises a pad detachably attachable to a lower distal end of the elongate rod to position the elongate rod in a substantially erect position on the ground, where either the first player or the second player can aim and strike the ball using the baseball bat. In an embodiment, the bearing assembly is a ball bearing.

### BRIEF DESCRIPTION OF THE DRAWINGS

FIG. 1 exemplarily illustrates a front perspective view of the baseball-training device, showing a first player and a second player training with the baseball-training device.

FIG. 2 exemplarily illustrates an enlarged view of the distal end of the baseball-training device.

### DETAILED DESCRIPTION OF THE INVENTION

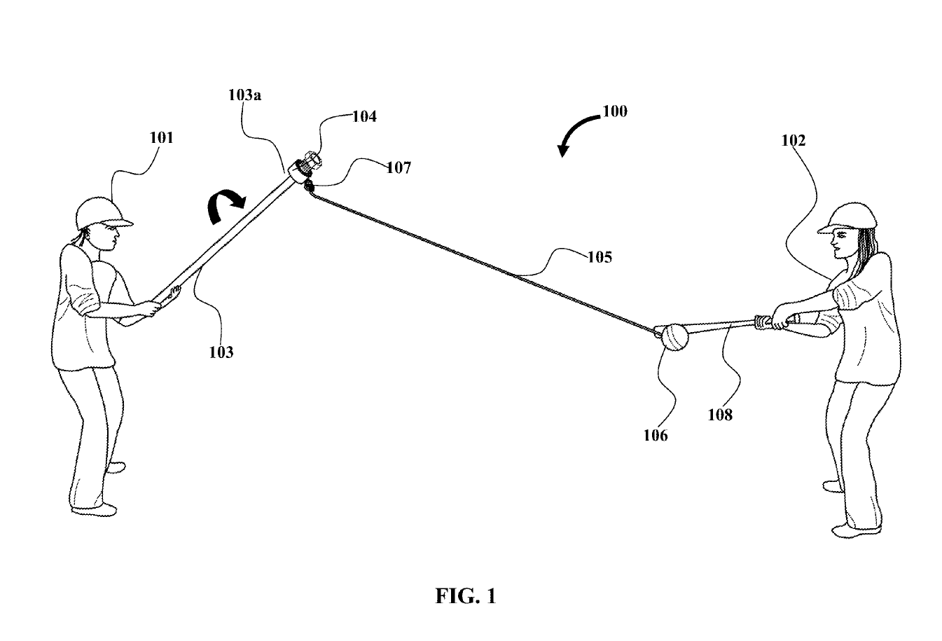

FIG. 1 exemplarily illustrates a front perspective view of the baseball-training device 100, showing a first player 101 and a second player 102 training with the baseball-training device 100. The baseball-training device 100 is configured for training a baseball player, for example, the first player 101 or the second player 102. The baseball-training device 100 comprises an elongate rod 103, a bearing assembly 104, a rope member 105, and a ball 106. The elongate rod 103 is configured to be held by the first player 101. The bearing assembly 104 is fixedly attached at a distal end 103a of the elongate rod 103, where the bearing assembly 104 is molded to the distal end 103a of the elongate rod 103 to form a rigid connection between the elongate rod 103 and the bearing assembly 104.

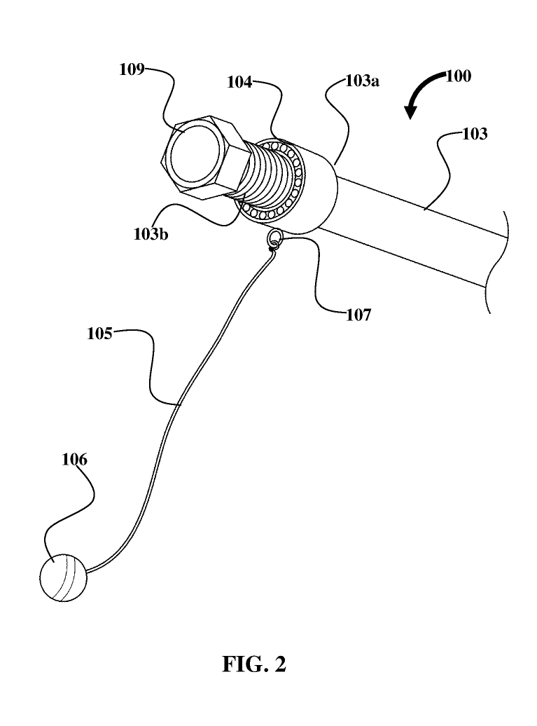

The rope member 105 is attached to a projected ring 107, as shown in FIG. 2, on the circumference of the bearing assembly 104, and the ball 106 is fastened to a distal end 105a of the rope member 105. The projected ring 107 is a welded portion which extends from the outer surface of the bearing assembly 104. The first player 101 rotates the elongate rod 103 in a predefined direction to allow the ball 106 to swing in a generally circular manner with respect to the axis of the elongate rod 103, where the second player 102 is required to aim and strike the ball 106 using a baseball bat 108. Here, the first player 101 provides training to the second player 102 by rotating the baseball-training device 100 so that the second player 102 gains aim to target and hit the ball 106 with better accuracy.

Since the ball 106 is not hit far, according to the conventional mode of baseball practice, the second player 102 gets significantly more amount of chances to hit the ball 106 since the ball 106 is consistently being hit within the same proximity of the baseball-training device 100. Thus, the baseball-training device 100 allows a player, for example, the first player 101 or the second player 102, to practice in a confined or populated area without damage to property or people. The baseball-training device 100 further eliminates any risk of physical injury to the pitcher who is managing the baseball bat 108, or the swing stick.

The baseball-training device 100 enables a person to competently train on baseball hitting, without any loss of time or energy related with the necessity to retrieve the balls, where the player 101 and/or 102 has to run far and return with the ball 106. The nature of the rope member 105 allows the second player 102 to strike the ball 106 considerably away from the first player 101, so that the second player 102 can strike the ball 106 to a safe distance away from the first player 101. The first player 101 can loosen his/her hand in the direction of strike of the second player 102, to prevent a quick return of the ball 106 which might injure the first player 101 if he/she fails to catch the ball 106 on return. In an embodiment, the rope member 105 is of any predefined length, that is, the different lengths of the rope member 105 allows the player 102 to vary his/her timing and trajectory of the ball 106. In an embodiment, the ball 106 fastened to the distal end of the rope member 105 is either a soft ball or a hard ball, and the ball 106 is of a predetermined size.

FIG. 2 exemplarily illustrates an enlarged view of the distal end of the baseball-training device 100. In an embodiment, the bearing assembly 104, for example, is a ball bearing. As shown in FIGS. 1 and 2, the bearing assembly 104 allows smooth operation of the baseball-training device 100, and the rope member 105 allows connecting different types of balls 106, for example, balls ranging from soft balls to hard balls, which will enable the player 102 to train on different modes of practice. A shown in FIGS. 1 and 3, the projected ring 107 is a welded portion which extends from the outer surface of the bearing assembly 104 to fasten the rope member 105. The baseball-training device 100 further comprises a nut 109 positioned at the distal end 103a of the elongate rod 103, where the nut 109 is configured to secure the ball bearing 104 at the distal end 103a of the elongate rod 103. The threaded section 103b at the distal end 103a of the elongate rod 103 allows the nut 109 to be tightened to secure the ball bearing 104.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

1. A baseball-training device configured for training a baseball layer, the baseball-training device comprising;
an elongate rod configured to be held by a first player;
a bearing assembly molded to a distal end of the elongate rod comprising a projected ring attached to an outer circumference surface of a ball bearing race, wherein the circumference surface race rotates about the axis of the elongate rod; and
a rope member removably attached to the projected ring on the circumference surface race of the bearing assembly, and a surface of a ball is fastened to a distal end of the rope member, wherein the elongate rod rotates to allow the ball to swing in a generally circular manner with respect to the axis of the elongate rod.

2. The baseball-training device of claim 1, wherein the rope member is of any predefined length.

3. The baseball-training device of claim 1, wherein the ball fastened to the distal end of the rope member is one of a soft ball and a hard ball, and wherein the ball is of a predetermined size.

4. (canceled)

5. The baseball-training device of claim 1, further comprising a nut positioned at the distal end of the elongate rod, wherein the nut is configured to secure the ball bearing at the distal end of the elongate rod and positioned within the axis of rotation and a perimeter formed by an inner circumference surface of the ball bearing.
